(19) United States
(12) Patent Application Publication
(10) Pub. No.: US 2012/0066070 A1
(43) Pub. Date: Mar. 15, 2012

(54) MANAGEMENT OF ADVERTISEMENTS INSERTED IN TEXT/MULTIMEDIA MESSAGES

(76) Inventors: Yigang Cai, Naperville, IL (US); Xiangyang Li, Beijing (CN)

(21) Appl. No.: 13/320,073

(22) PCT Filed: Jun. 1, 2009
(86) PCT No.: PCT/US2009/045854

§ 371 Date: Nov. 11, 2011

(51) Int. Cl. G06Q 30/02

(52) U.S. Cl. 705/14.64

(57) ABSTRACT

Message filtering systems and associated methods are disclosed for filtering advertisements that are inserted in a text/multimedia message by an originating network. The message filtering system includes a criteria database that stores filter criteria defined for a user of a mobile device. The filter criteria are defined to filter advertisements on a per message basis based on the content of the advertisement and/or the source of the advertisement. The message filtering system further includes a message processor that receives a Mobile Terminated (MT) text/multimedia message from an originating network that is destined for the mobile device. The message processor identifies an advertisement inserted in the text/multimedia message by the originating network, and identifies the filter criteria defined for the user of the mobile device as stored in the criteria database. The message processor then filters the identified advertisement in the text/multimedia message based on the filter criteria.

### BACKGROUND

1. Field of the Invention

The invention is related to the field of communications and, in particular, to delivery of text/multimedia messages.

2. Statement of the Problem

In many mobile networks, text/multimedia messaging has become a very popular mode of communication. Short Message Service (SMS) is a communication protocol allowing the interchange of short text messages (i.e., 160 characters) between mobile devices. Multimedia Message Service (MMS) is a communication protocol allowing the interchange of multimedia messages (i.e., digital pictures, media clips, etc) between mobile devices. Often times, mobile users more frequently use text/multimedia messaging for communication than voice calls.

Text/multimedia messages are presently transmitted over signaling channels of a voice network, such as over SS7 channels. A typical voice network includes a Radio Access Network (RAN) that provides an air interface to a mobile device, and a core network that connects the RAN to other networks, such as the PSTN or another RAN. The core network includes a switching system and a subscriber server for serving the mobile device. For instance, in a UMTS network, the switching system may comprise a Mobile Switching Center (MSC) and the subscriber server may comprise a Home Location Register (HLR). In an IP Multimedia Subsystem (IMS) network, the switching system may comprise a Call Session Control Function (CSCF) and the subscriber server may comprise a Home Subscriber Server (HSS). The core network also connects to an SMS Center (SMS-C) or an MMS Center (MMS-C). The SMS-C or MMS-C is the entity which does the job of storing and forwarding text/multimedia messages to and from mobile devices.

The following illustrates an example of delivering a text message from an originating mobile device to a destination mobile device. To start, a sender originates the text message through the originating mobile device, and the originating mobile device sends the text message to an originating SMS-C implemented in the network serving the originating mobile device. This network is referred to herein as the originating network or the originating-side network. The originating SMS-C in the originating network receives and stores the text message. The originating SMS-C then queries a Home Location Register (HLR) to identify routing information for the text message. The HLR responds to the query with the routing information, and the originating SMS-C routes the text message to a terminating SMS-C based on the routing information. The terminating SMS-C is implemented in the network that is serving the destination mobile device. This network is referred to herein as the terminating network or the terminating-side network. The terminating SMS-C receives and stores the text message. The terminating SMS-C then queries an HLR in the terminating network to identify routing information for the text message. The HLR responds to the query from the terminating SMS-C with the routing information for the text message. The terminating SMS-C then forwards the text message to the destination mobile device based on the routing information. A similar process occurs for the delivery of a multimedia message.

There may be instances where the originating SMS-C or the originating MMS-C inserts an advertisement into the text/multimedia message being delivered to the destination mobile device. For example, the network operator for the originating network may contract with a third party advertiser to insert advertisements into text/multimedia messages that are handled by the originating network. Thus, when the originating SMS-C or MMS-C receives the text/multimedia message, the originating SMS-C or MMS-C may insert an advertisement (i.e., a banner) into the payload of the text/multimedia message. The text/multimedia message will thus include the original content of the sender, and the advertisement will be appended to the end of the message. After inserting the advertisement, the originating SMS-C or MMS-C forwards the text/multimedia message to the terminating network, which in turn forwards the text/multimedia message to the destination mobile device. Unfortunately, some recipients of text/multimedia messages may find the advertisements inserted by the originating network to be annoying.

### SUMMARY

Embodiments described herein are able to filter advertisements, inserted in text/multimedia messages, in the terminating network. Thus, if an originating SMS-C or MMS-C in the originating network inserts an advertisement into a text/multimedia message, the terminating network is able to filter the advertisement based on filter criteria defined for the destination of the text/multimedia message. Thus, the terminating network is advantageously able to control the advertisements that are included in text/multimedia messages destined for its subscribers.

In one embodiment, a message filtering system is disclosed that is implemented in a terminating network. For example, the message filtering system may be implemented in an SMS-C, an MMS-C, or another network element. The message filtering system may also be implemented in a mobile device. The message filtering system includes a criteria database operable to store filter criteria defined for a user of a mobile device. The filter criteria are defined to filter advertisements in text/multimedia messages on a per message basis based on the content of the advertisement and/or the source of the advertisement. The message filtering system further includes a message processor operable to receive a Mobile Terminated (MT) text/multimedia message from an originating network that is destined for the mobile device. The message processor is further operable to identify an advertisement inserted in the text/multimedia message by the originating network, and to identify the filter criteria defined for the user of the mobile device as stored in the criteria database. The message processor is further operable to filter the identified advertisement based on the filter criteria. For example, the message processor may modify or delete the advertisement in the text/multimedia message.

Other exemplary embodiments may be described below.

### DESCRIPTION OF THE DRAWINGS

Some embodiments of the present invention are now described, by way of example only, and with reference to the accompanying drawings. The same reference number represents the same element or the same type of element on all drawings.

FIG. 1 illustrates a communication network in an exemplary embodiment.

FIG. 2 illustrates a message filtering system in an exemplary embodiment.

FIG. 3 is a flow chart illustrating a method of filtering an advertisement in a text/multimedia message in an exemplary embodiment.

FIG. 4 is a flow chart illustrating a method of notifying an originating network of a filtered advertisement in an exemplary embodiment.

FIG. 5 is a flow chart illustrating a method of inserting an advertisement in a terminating network in an exemplary embodiment.

FIG. 6 illustrates another communication network in an exemplary embodiment.

FIG. 7 illustrates a message filtering system having filtered a text message in an exemplary embodiment.

FIG. 8 illustrates a message filtering system having filtered another text message in an exemplary embodiment.

### DESCRIPTION OF EMBODIMENTS

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents.

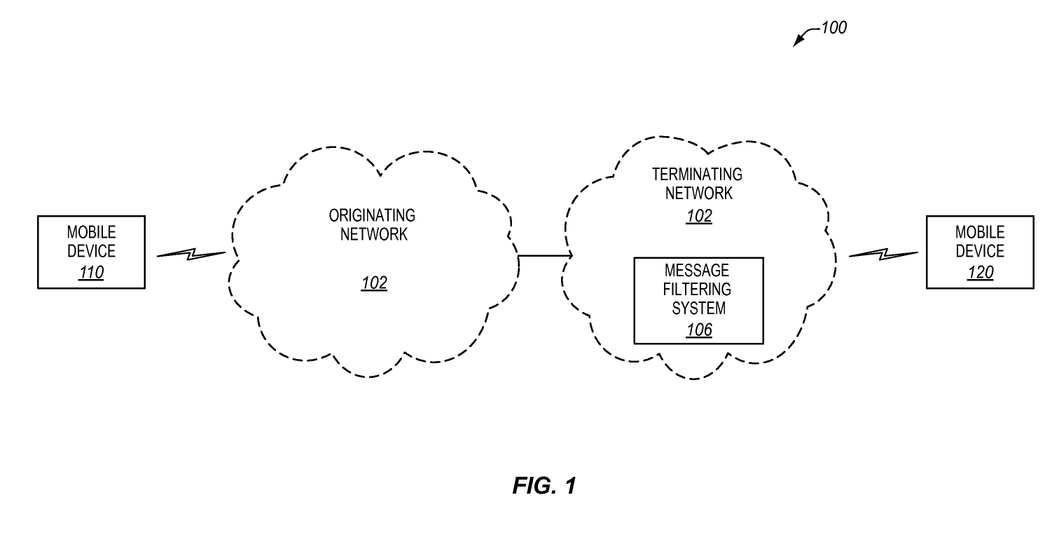

FIG. 1 illustrates a communication network 100 in an exemplary embodiment. Communication network 100 includes an originating network 102 operable to serve a first mobile device 110. Communication network 100 also includes a terminating network 104 operable to serve a second mobile device 120. Originating network 102 and terminating network 104 may comprise circuit-based networks, such as a CDMA network or a GSM network, may comprise packet-based networks, such as an IP Multimedia Subsystem (IMS) network, or a mix of the two. Originating network 102 and terminating network 104 may be separate networks operated by different service providers. For instance, originating network 102 may be operated by Sprint® while terminating network 104 may be operated by Verizon Wireless. Originating network 102 and terminating network 104 may also be implemented in different countries.

Originating network 102 is termed “originating” as it is operable to serve a mobile device 110 that originates a text/multimedia message. Likewise, terminating network 104 is termed “terminating” as it is operable to serve a mobile device 120 that is destined to receive the text/multimedia message originated by mobile device 110. From the stand point of mobile device 120, the text/multimedia message may be referred to as a Mobile Terminated (MT) text/multimedia message. In this embodiment, terminating network 104 includes a message filtering system 106. Message filtering system 106 comprises any system, server, application, or function operable to filter text/multimedia messages forwarded to terminating network 104 by originating network 102. Message filtering system 106 may be implemented as a stand-alone network node in terminating network 104, or may be implemented in another network node in terminating network 104, such as in a Short Message Service Center (SMS-C), a Multimedia Message Service Center (MMS-C), a Mobile Switching Center (MSC), a Call Session Control Function (CSCF), an application server, etc. Also, although message filtering system 106 is shown in FIG. 1 as being inside of terminating network 104, message filtering system 106 may also be implemented within mobile device 120.

Mobile devices 110 and 120 comprise any devices operable to communicate via wireless signals, such as a mobile phone, a PDA, a mobile VoIP phone, etc. Although mobile devices 110 and 120 are referenced in FIG. 1, those skilled in the art understand that text/multimedia messages may be exchanged using devices other than a mobile device. For example, a text/multimedia message may be exchanged through a web site application, through an email application, etc.

A text/multimedia message comprises any store-and-forward type message that is either text-based or multimedia-based. If the message is text-based, then it may comprise a Short Message Service (SMS) message. If the message is multimedia-based, then it may comprise a Multimedia Message Service (MMS) message.

Any of the various elements shown in the figures or described herein may be implemented as hardware, software, firmware, or some combination of these. For example, an element may be implemented as dedicated hardware. Dedicated hardware elements may be referred to as “processors”, “controllers”, or some similar terminology. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, a network processor, application specific integrated circuit (ASIC) or other circuitry, field programmable gate array (FPGA), read only memory (ROM) for storing software, random access memory (RAM), non volatile storage, logic, or some other physical hardware component or module.

Also, an element may be implemented as instructions executable by a processor or a computer to perform the functions of the element. Some examples of instructions are software, program code, and firmware. The instructions are operational when executed by the processor to direct the processor to perform the functions of the element. The instructions may be stored on storage devices that are readable by the processor. Some examples of the storage devices are digital or solid-state memories, magnetic storage media such as a magnetic disks and magnetic tapes, hard drives, or optically readable digital data storage media.

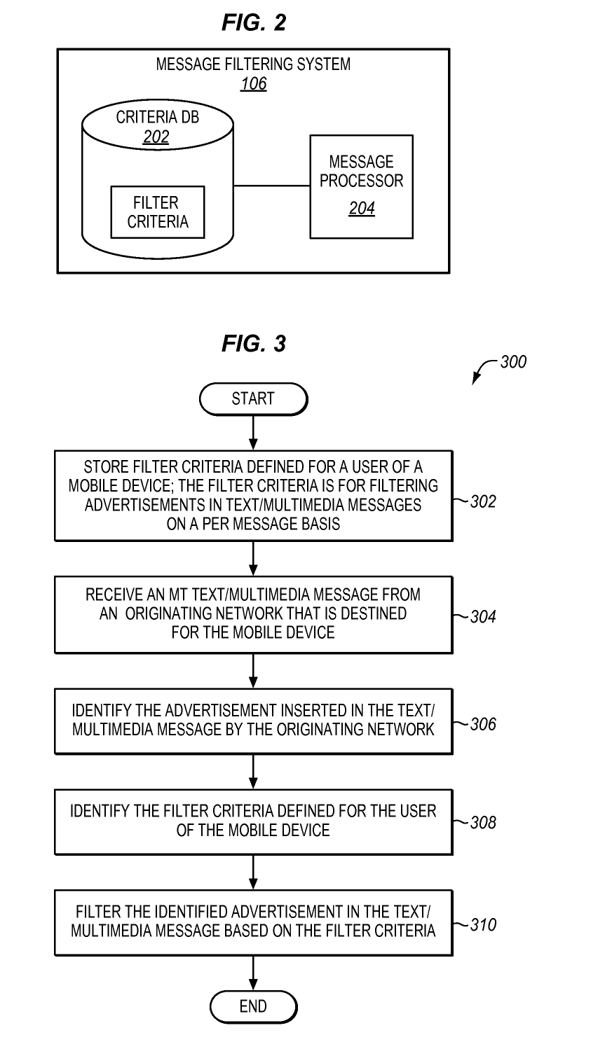

FIG. 2 illustrates message filtering system 106 in an exemplary embodiment. In this embodiment, message filtering system 106 includes a criteria database 202 and a message processor 204. Criteria database 202 comprises any storage system operable to store filter criteria defined for a user of terminating network 104 (see also FIG. 1). Message processor 204 comprises any device, component, system, or application operable to filter advertisements inserted in text/multimedia messages by originating network 102.

Filter criteria as stored in criteria database 202 comprises any rules, conditions, policies, or other data defined for a user of a mobile device for filtering advertisements in text/multimedia messages on a per message basis. Filtering of an advertisement may mean modifying the advertisement in some way, or deleting the advertisement all together. An advertisement, as referred to herein, comprises any supplemental information added to the payload of a text/multimedia message by a network.

The filter criteria are typically based on the content of the advertisement and/or the source of the advertisement. For example, the filter criteria may be based on a category of the advertisement, such as sports, weather, news, movies, etc. Thus, the filter criteria may define a rule that sports advertisements are allowed, but all other advertisements are not allowed. The filter criteria may be based on one or more key words in the advertisement. Thus, the filter criteria may define a rule that certain advertisements that include a key word are not allowed, or that the key word has to be removed. The filter criteria may be based on the language of the advertisement. Thus, the filter criteria may define a rule that advertisements need to be in a particular language, or the advertisements need to be translated to a particular language. The filter criteria may be based on the size of the advertisement. Thus, the filter criteria may define a rule that advertisements need to be below a threshold size, or reduced down below a threshold size. The filter criteria may be based on the source address or sender information. Thus, the filter criteria may define a rule that advertisements originated from a foreign country or from a particular originating network are not allowed.

The filter criteria are defined in a way so that text/multimedia messages may be filtered on a per message basis. For example, the filter criteria are not defined so generally as to block or delete all advertisements to a user. The filter criteria are defined to modify or delete an advertisement based on the content and/or source of the individual advertisement. Thus, the filter criteria are intended to look at each individual advertisement, and filter the advertisement on a case-by-case basis.

In FIG. 1, assume that mobile device 110 sends a text/multimedia message to originating network 102 that is intended for mobile device 120. Those skilled in the art will appreciate that the text/multimedia message is encapsulated in a signaling message, such as an SS7 message or a SIP message. Originating network 102 receives the text/multimedia message, and identifies an advertisement to insert in the text/multimedia message. For example, originating network 102 may insert its own advertisement, or may contract with a third party to insert some type of paid advertisement. Originating network 102 then inserts the advertisement in the text/multimedia message, and forwards the text/multimedia message to terminating network 104. Terminating network 104 is able to filter the advertisement inserted in the text/multimedia message before the text/multimedia message is forwarded to mobile device 120, as is illustrated in FIG. 3.

FIG. 3 is a flow chart illustrating a method 300 of filtering an advertisement in a text/multimedia message in an exemplary embodiment. The steps of method 300 will be described with reference to communication network 100 in FIG. 1 and message filtering system 106 in FIG. 2, but those skilled in the art will appreciate that method 300 may be performed in other networks and systems. Also, the steps of the flow chart in FIG. 3 are not all inclusive and may include other steps not shown, and the steps may be performed in an alternative order.

In step 302, criteria database 202 stores the filter criteria defined for a user of mobile device 120. Criteria database 202 may also store the filter criteria defined for other users of terminating network 104. The filter criteria is pre-provisioned in criteria database 202, and may be defined by the user of mobile device 120 and/or the service provider operating terminating network 104.

In step 304, message processor 204 receives the Mobile Terminated (MT) text/multimedia message from originating network 102 that is destined for mobile device 120. The MT text/multimedia message includes the advertisement inserted by originating network 102. In step 306, message processor 204 identifies the advertisement inserted in the text/multimedia message by originating network 102. In step 308, message processor 204 identifies the filter criteria defined for the user of mobile device 120 as stored in criteria database 202. In step 310, message processor 204 filters the identified advertisement in the text/multimedia message based on the filter criteria for the user.

In filtering the identified advertisement, message processor 204 may modify the identified advertisement based on the filter criteria. In one example, message processor 204 may translate the identified advertisement from a first language to a second language based on the filter criteria. In another example, message processor 204 may remove one or more key words from the identified advertisement based on the filter criteria, or add one or more key words to the identified advertisement. In another example, message processor 204 may reduce the size of the identified advertisement based on the filter criteria.

Message processor 204 may alternatively delete the identified advertisement based on the filter criteria. As described above however, the filter criteria is not simply a global definition of “delete all advertisements”. Message processor 204 actually processes the advertisement on a message-by-message basis based on the filter criteria. If particular conditions are satisfied for this particular advertisement, then message processor 204 may delete the advertisement.

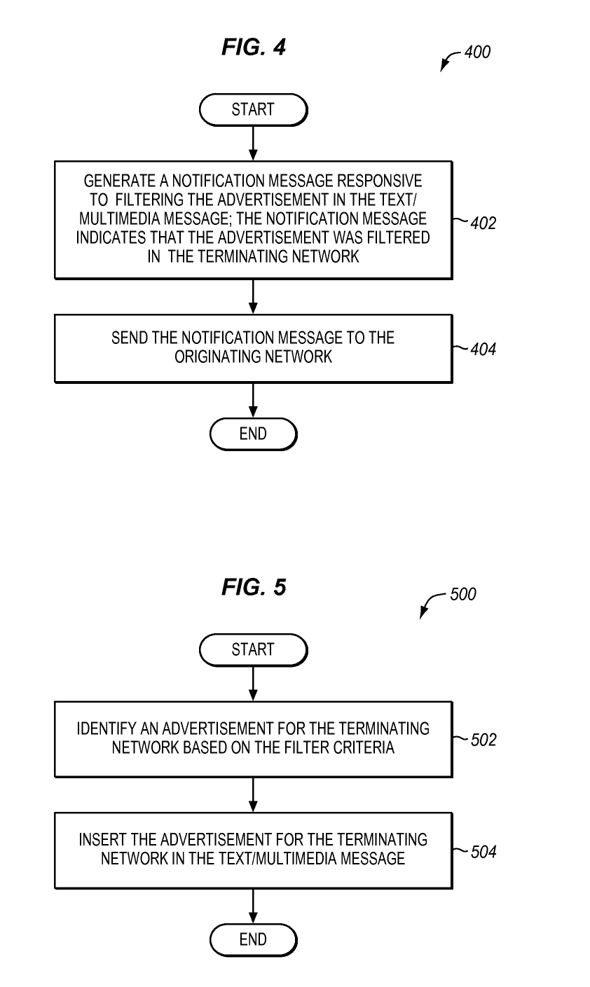

After filtering the advertisement inserted by originating network 102, terminating network 104 may notify originating network 102 that the advertisement was filtered. FIG. 4 is a flow chart illustrating a method 400 of notifying originating network 102 of a filtered advertisement in an exemplary embodiment. In step 402, message processor 204 generates a notification message responsive to filtering the advertisement in the text/multimedia message. The notification message includes a status report indicating that the advertisement was filtered in terminating network 104, and may include details on how the advertisement was filtered, such as how the advertisement was modified or that the advertisement was deleted. In step 404, message processor 204 sends the notification message to originating network 102. Originating network 102 may then use the notification to determine whether to charge or refund the sender or the advertisement content provider if the advertisement has been modified or deleted. Terminating network 104 may also send an instruction to originating network 102, such as a cause code, to block future advertisements such as this.

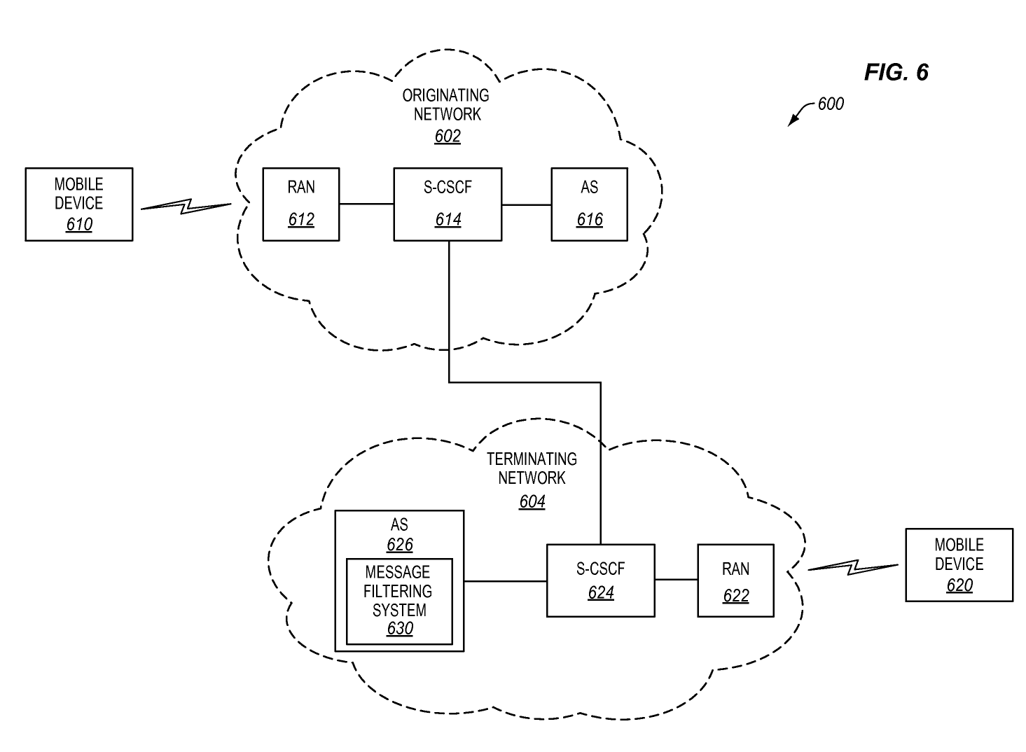

In addition to filtering the advertisement inserted by originating network 102, terminating network 104 may insert its own advertisement. FIG. 5 is a flow chart illustrating a method 500 of inserting an advertisement in terminating network 104 in an exemplary embodiment. In step 502, message processor 204 identifies an advertisement based on the filter criteria stored in criteria database 202. In addition to defining how to filter advertisements inserted by originating network 102, the filter criteria may further define advertisements that are allowed by terminating network 104. Thus, message processor 204 identifies an advertisement that is allowed by the filter criteria. The advertisement may be its own, or may be an advertisement of a third party that has contracted with terminating network 104. In step 504, message processor 204 inserts the advertisement for terminating network 104 in the text/multimedia message.

At this point with the initial advertisement inserted by originating network 102, and possibly another advertisement inserted by terminating network 104, terminating network 104 may then forward the text/multimedia message to mobile device 120. Because terminating network 104 is able to filter the advertisement in the text/multimedia message, the user of mobile device 120 is not bothered with unwanted advertisements. The user is thus more likely to be satisfied with his/her service provider.

### EXAMPLE

FIG. 6 illustrates another communication network 600 in an exemplary embodiment. In this embodiment, communication network 600 includes an originating network 602 operable to serve a first mobile device 610. Communication network 600 also includes a terminating network 604 operable to serve a second mobile device 620. Originating network 602 includes a Radio Access Network (RAN) 612, which comprises any radio or wireless network that interfaces a mobile device with a core network. The core network of originating network 602 is IMS-based, and is represented by Serving-Call Session Control Function (S-CSCF) 614 and application server 616. Application server 616 is able to handle text/multimedia messages. For example, application server 616 may represent an SMS-C or an MMS-C.

Terminating network 604 also includes a Radio Access Network (RAN) 622. And, the core network of terminating network 604 is also IMS-based, and is represented by S-CSCF 624 and application server 626. Application server 626 is able to handle text/multimedia messages within terminating network 604. For example, application server 626 may represent an SMS-C or an MMS-C. In this embodiment, application server 626 also includes message filtering system 630. Message filtering system 630 is able to filter advertisements in the text/multimedia messages. Message filtering system 630 stores filter criteria defined for a user of mobile device 620, and other users of terminating network 604.

Those skilled in the art will appreciate that originating network 602 and/or terminating network 604 may have different core networks in other embodiments. For example, terminating network 604 may comprise a circuit-based core network in another embodiment, with an MSC and an SMS-C/MMS-C instead of S-CSCF 624 and application server 626.

Assume for this example that a user of mobile device 610 initiates a text message to a user of mobile device 620. The text message reads “Train is late, will arrive at 9”. Mobile device 610 encapsulates the text message in a SIP MESSAGE, and sends the SIP MESSAGE to S-CSCF 614 in originating network 602 through RAN 612. S-CSCF 614 identifies the SIP MESSAGE as including a text message, and forwards the SIP MESSAGE to application server 616. Application server 616 stores the text message and determines where to route the text message, which is to terminating network 604. In addition, application server 616 inserts an advertisement in the text message. The advertisement reads “Stay at The Inn. Tower Bridge Road. $155”. Application server 616 then forwards the SIP MESSAGE, which includes the text message and the advertisement, to terminating network 604.

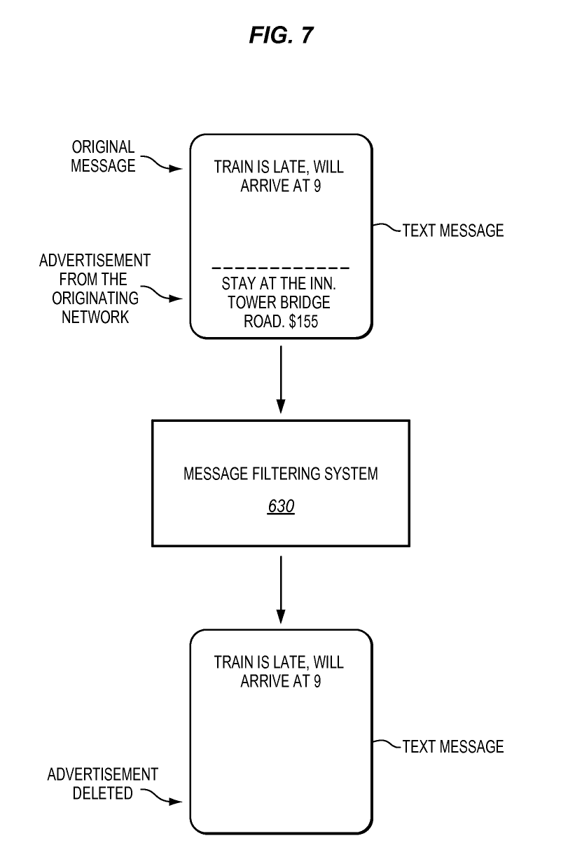

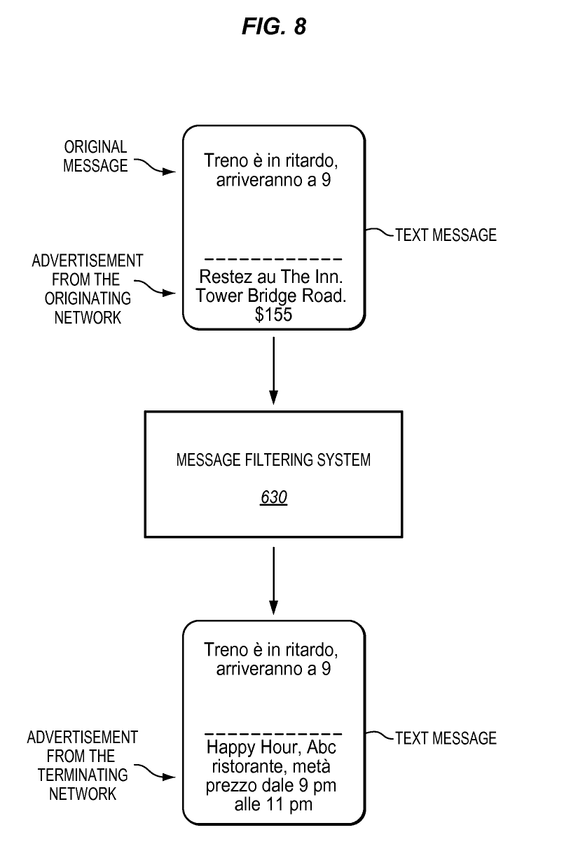

S-CSCF 624 receives the SIP MESSAGE from originating network 602, and forwards the SIP MESSAGE to application server 626. Application server 626 stores the text message and determines where to route the text message, which is to mobile device 620. In addition, message filtering system 630 processes the text message as described below. First, message filtering system 630 identifies the advertisement inserted in the text message by originating network 602. Message filtering system 630 then identifies the filter criteria defined for the user of mobile device 620. Assume for this example that the filter criteria includes a rule that advertisements from originating network 602 are not allowed. Thus, message filtering system 630 filters the advertisement in the text message by deleting the advertisement from the text message. FIG. 7 illustrates message filtering system 630 having filtered the text message in an exemplary embodiment. Application server 626 then forwards a SIP MESSAGE to mobile device 620 that includes the filtered text message.

In another example, assume again that a user of mobile device 610 initiates a text message to a user of mobile device 620. The user of mobile device 610 is travelling in France, and originating network 602 is located in France. The user of mobile device 620 is in Italy, and terminating network 604 is located in Italy. The text message reads “Treno è in ritardo, arriveranno a 9” (which in English reads “Train is late, will arrive at 9”). Mobile device 610 encapsulates the text message in a SIP MESSAGE, and sends the SIP MESSAGE to S-CSCF 614 in originating network 602 through RAN 612. S-CSCF 614 identifies the SIP MESSAGE as including a text message, and forwards the SIP MESSAGE to application server 616. Application server 616 stores the text message and determines where to route the text message, which is to terminating network 604. In addition, application server 616 inserts an advertisement in the text message. The advertisement reads “Restez au The Inn. Tower Bridge Road. $155” (which in English reads “Stay at The Inn. Tower Bridge Road. $155”). Because originating network 602 is located in France, the advertisement is in French. Application server 616 then forwards the SIP MESSAGE, which includes the text message and the advertisement, to terminating network 604.

S-CSCF 624 receives the SIP MESSAGE from originating network 602, and forwards the SIP MESSAGE to application server 626. Application server 626 stores the text message and determines where to route the text message, which is to mobile device 620. In addition, message filtering system 630 processes the text message as described below. First, message filtering system 630 identifies the advertisement inserted in the text message by originating network 602. Message filtering system 630 then identifies the filter criteria defined for the user of mobile device 620. Assume for this example that the filter criteria includes a rule that advertisements in Italian are allowed. Thus, message filtering system 630 filters the advertisement in the text message by deleting the advertisement in French. Message filtering system 630 may also insert another advertisement in the place of the deleted advertisement. Thus, message filtering system 630 identifies another advertisement based on the filter criteria that is in Italian, and inserts the advertisement in the text message. The advertisement reads “Happy Hour, Abc ristorante, meta prezzo dale 9 pm alle 11 pm” (which in English reads “Happy Hour, Abc restaurant, half price from 9 pm to 11 pm”). FIG. 8 illustrates message filtering system 630 having filtered the text message in an exemplary embodiment. Application server 626 then forwards a SIP MESSAGE to mobile device 620 that includes the filtered text message.

Although specific embodiments were described herein, the scope of the invention is not limited to those specific embodiments. The scope of the invention is defined by the following claims and any equivalents thereof.

We claim:

1. A message filtering system implemented in a terminating network, the message filtering system comprising:
a criteria database operable to store filter criteria defined for a user of a mobile device for filtering advertisements in text/multimedia messages on a per message basis based on at least one of the content of the advertisement and the source of the advertisement; and
a message processor operable to receive a Mobile Terminated (MT) text/multimedia message from an originating network that is destined for the mobile device, to identify an advertisement inserted in the text/multimedia message by the originating network, to identify the filter criteria defined for the user of the mobile device as stored in the criteria database, and to filter the identified advertisement in the text/multimedia message based on the filter criteria.

2. The message filtering system of claim 1 wherein:
the message processor is further operable to modify the identified advertisement based on the filter criteria.

3. The message filtering system of claim 2 wherein:
the message processor is further operable to translate the identified advertisement from a first language to a second language based on the filter criteria.

4. The message filtering system of claim 2 wherein:
the message processor is further operable to remove one or more key words from the identified advertisement based on the filter criteria.

5. The message filtering system of claim 2 wherein:
the message processor is further operable to reduce the size of the identified advertisement based on the filter criteria.

6. The message filtering system of claim 1 wherein:
the message processor is further operable to delete the identified advertisement based on the filter criteria.

7. The message filtering system of claim 1 wherein:
the message processor is further operable to identify another advertisement based on the filter criteria, and to insert the other advertisement in the text/multimedia message.

8. The message filtering system of claim 1 wherein:
the message processor is further operable to generate a notification message, responsive to filtering the identified advertisement in the text/multimedia message, indicating that the advertisement was filtered, and to send the notification message to the originating network.

9. A method of filtering advertisements in text/multimedia messages in a terminating network, the method comprising:
storing filter criteria defined for a user of a mobile device for filtering advertisements in text/multimedia messages on a per message basis based on at least one of the content of the advertisement and the source of the advertisement;
receiving a Mobile Terminated (MT) text/multimedia message from an originating network that is destined for the mobile device;
identifying an advertisement inserted in the text/multimedia message by the originating network;
identifying the filter criteria defined for the user of the mobile device; and
filtering the identified advertisement in the text/multimedia message based on the filter criteria.

10. The method of claim 9 wherein filtering the identified advertisement comprises:
modifying the identified advertisement based on the filter criteria.

11. The method of claim 10 wherein modifying the identified advertisement comprises:
translating the identified advertisement from a first language to a second language based on the filter criteria.

12. The method of claim 10 wherein modifying the identified advertisement comprises:
removing one or more key words from the identified advertisement based on the filter criteria.

13. The method of claim 10 wherein modifying the identified advertisement comprises:
reducing the size of the identified advertisement based on the filter criteria.

14. The method of claim 9 wherein filtering the identified advertisement comprises:
deleting the identified advertisement based on the filter criteria.

15. The method of claim 9 further comprising:
identifying another advertisement based on the filter criteria; and
inserting the other advertisement in the text/multimedia message.

16. The method of claim 9 further comprising:
generating a notification message responsive to filtering the identified advertisement in the text/multimedia message indicating that the advertisement was filtered; and
sending the notification message to the originating network.

17. A computer readable medium tangibly embodying programmed instructions which, when executed by a computer system, are operable to execute a method of filtering advertisements in text/multimedia messages in a terminating network, the method comprising:
storing filter criteria defined for a user of a mobile device for filtering advertisements in text/multimedia messages on a per message basis based on at least one of the content of the advertisement and the source of the advertisement;
receiving a Mobile Terminated (MT) text/multimedia message from an originating network that is destined for the mobile device;
identifying an advertisement inserted in the text/multimedia message by the originating network;
identifying the filter criteria defined for the user of the mobile device; and
filtering the identified advertisement in the text/multimedia message based on the filter criteria.

18. The computer readable medium of claim 17 wherein filtering the identified advertisement comprises:
modifying the identified advertisement based on the filter criteria.

19. The computer readable medium of claim 17 wherein filtering the identified advertisement comprises:
deleting the identified advertisement based on the filter criteria.

20. The computer readable medium of claim 17 wherein the method further comprising:
generating a notification message responsive to filtering the identified advertisement in the text/multimedia message indicating that the advertisement was filtered; and
sending the notification message to the originating network.
